(19) United States
(12) Patent Application Publication
(10) Pub. No.: US 2009/0180631 A1
(43) Pub. Date: Jul. 16, 2009

(54) PERSONAL SOUND SYSTEM FOR DISPLAY OF SOUND PRESSURE LEVEL OR OTHER ENVIRONMENTAL CONDITION

(75) Inventors: NICHOLAS R. MICHAEL, San Francisco, CA (US); Ephram Cohen, San Francisco, CA (US); Caslav V. Pavlovic, Palo Alto, CA (US); Meena Ramani, Mountain View, CA (US)

Correspondence Address: HAYNES BEFFEL & WOLFELD LLP, P O BOX 366, HALF MOON BAY, CA, 94019, US

(73) Assignee: SOUND ID, Palo Alto, CA (US)

(21) Appl. No.: 12/350,823

(22) Filed: Jan. 8, 2009

Related U.S. Application Data
(60) Provisional application No. 61/020,189, filed on Jan. 10, 2008.

(51) Int. Cl. H04R 29/00; H04B 1/38

(52) U.S. Cl. 381/58; 455/566

(57) ABSTRACT

A cell phone providing a display of sound pressure level or other environmental condition is described. An ear-level module, which includes a microphone or other sensor, and processing resources for analyzing the input from the microphone to provide a measure of an environmental condition, such as sound pressure level, at the ear, and deliver it to a cell phone or other hand held device for display in a manner readable by the user. The companion cell phone provides a display and supporting processing resources, presenting a graphical meter view. Alternatively, the audio data or other measurement is produced using a microphone on the cell phone.

### CROSS-REFERENCE TO RELATED APPLICATION

Benefit is claimed of U.S. Provisional Application No. 61/020,189, filed 10 Jan. 2008, entitled PERSONAL SOUND SYSTEM FOR DISPLAY OF SOUND PRESSURE LEVEL OR OTHER ENVIRONMENTAL CONDITION.

### BACKGROUND OF THE INVENTION

1. Field of the Invention

The present invention relates to personalized sound systems, including a cell phone, or a combination of an ear-level device adapted to be worn on the ear and provide audio processing and a cell phone or other hand held device, and use of such systems for sound pressure level measurement and display, or measurement and display of other environmental conditions.

2. Description of Related Art

Mobile phones are widely used devices with significant processing power. Modern phones also include usable displays, making them suitable platforms for a wide variety of applications.

One area in which the processing power of mobile phones can be utilized is the adaptation of the audio output to an individual's hearing profile. For example, U.S. Pat. No. 6,944,474 B2, by Rader et al., describes a mobile phone with audio processing functionality that can be adapted to the hearing profile of the user, addressing many of the problems of the use of mobile phones by hearing impaired persons, including the idea of sensing background noise and applying the information to dynamically adjusting processing of sound in the mobile phone. See also, International Publication No. WO 01/24576 A1, entitled PRODUCING AND STORING HEARING PROFILES AND CUSTOMIZED AUDIO DATA BASED (sic), by Pluvinage et al., which describes a variety of applications of hearing profile data.

With improved wireless technologies, such as Bluetooth® technology, techniques have been developed to couple hearing aids using wireless networks to other devices, for the purpose of programming the hearing aid and for coupling the hearing aid with sources of sound other than the ambient environment. In copending U.S. patent application Ser. No. 11/569,499; filed 21 Nov. 2006; entitled PERSONAL SOUND SYSTEM INCLUDING MULTI-MODE EAR-LEVEL MODULE WITH PRIORITY LOGIC, which is incorporated by reference as if fully set forth herein, an ear-level module is described with processing resources usable for adaptation of the audio at the ear-level module according to a user's hearing profile, and for a variety of functions that take advantage of the processor on the ear-level module and of communication with a mobile phone.

It is often useful to measure an environmental characteristic in a listening environment so that persons in that environment can take action to avoid harm to their hearing or make other adjustments to respond to conditions in the environment. It is desirable to provide systems that make this information more available to consumers without requiring the use of specialized equipment.

### SUMMARY OF THE INVENTION

A mobile phone is described that includes resources for displaying a sound pressure level measurement, or a measurement of another characteristic of the immediate environment. The data used for the measurement is detected either at an ear-level module such as a hearing aid or a headset, or at the mobile phone.

A personal sound system is described that includes an ear-level module, which includes a microphone or other sensor, and processing resources for analyzing the input from the microphone or other sensor to provide a measure of an environmental condition, such as sound pressure level or temperature, at the ear, and deliver it to a cell phone or other hand held device for display in a manner readable by the user.

In an alternative, the microphone, or other sensor, and processing resources used for sound pressure level measurement and display, or measurement and display of other environmental conditions, are provided on the mobile phone.

The microphone data from the ear-level module or from a sensor on the mobile phone is processed according to technology provided herein, to obtain sound pressure level of the immediate environment in decibels, for example, as used in standard sound meters. A frequency weighting may or may not be applied to the data. A standard “A-weighting” defined in industry standards relating to the measurement of perceived loudness may be used.

The ear-level module includes a radio for transmitting and receiving communication signals encoding audio data, an audio transducer, one or more microphones, a user input and control circuitry. In embodiments of the technology, the ear-level module is configured with hearing aid functionality for processing audio received on one or more of the microphones according to a hearing profile of the user, and playing the processed sound back on the audio transducer. The control circuitry includes logic for communication using the radio with a plurality of sources of audio data in memory storing a set of variables for processing the audio data. Logic on the ear-level module is operable in a plurality of signal processing modes in addition to, or combined with, the mode described above for delivering measurement data to a companion hand held phone.

Other aspects and advantages of the present invention can be seen on review of the drawings, the detailed description and the claims, which follow.

### BRIEF DESCRIPTION OF THE DRAWINGS

FIG. 1 illustrates a wireless audio network including a multimode ear-level module and a plurality of other audio sources, along with a wireless configuration network including a sound pressure level display on the mobile phone.

FIG. 2 is a system block diagram of data processing resources in the multimode ear module including sensors and computing resources of measuring an environmental condition.

FIG. 3 is a simplified block diagram of a mobile phone, representative of personal communication devices according to the present invention, including computing resources for displaying measurement of an environmental condition.

FIG. 4 is a drawing of a mobile phone including a graphical sound pressure level display.

### DETAILED DESCRIPTION

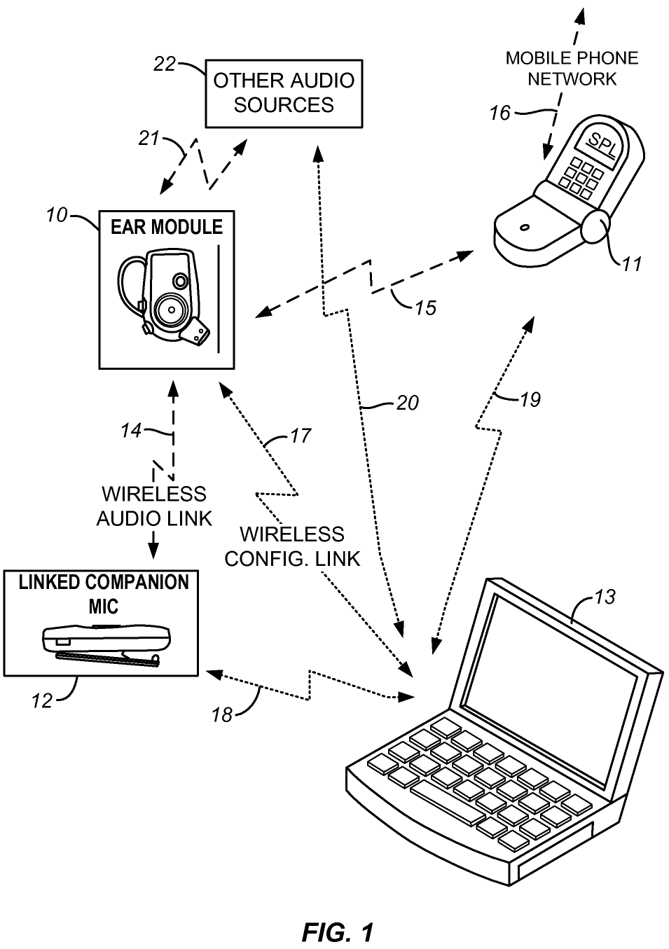

A detailed description of embodiments of the present invention is provided with reference to the FIGS. 1-4.

FIG. 1 illustrates a wireless network which extends the capabilities of an ear module 10, adapted to be worn at ear level, and operating in multiple modes including a mode in which data indicating a measurement of an environmental condition at the ear-level module is transmitted to a companion device, such as a mobile phone 11. The ear module 10 can include a hearing aid mode having hearing aid functionality. The network facilitates techniques for providing personalized sound from a plurality of audio sources such as mobile phones 11, other audio sources 22 such as televisions and radios, and with a linked companion microphone 12. In addition, a wireless network provides communication channels for configuring the ear module 10 and other audio sources (“companion modules”) in the network using a configuration host 13, which comprises a program executed on a computer that includes an interface to the wireless network. In one embodiment described herein, the wireless audio links 14, 15, 21 between the ear module 10 and the linked companion microphone 12, between the ear module 10 and the companion mobile phone 11 (See, FIG. 37), and between the ear module 10 and other companion audio sources 22, respectively, are implemented according to Bluetooth® compliant synchronous connection-oriented SCO channel protocol (See, for example, Specification of the Bluetooth System, Version 2.0, 4 Nov. 2004). Wireless link 16 couples the mobile phone 11 to a network service provider for the mobile phone service. The wireless configuration links 17, 18, 19, 20 between the configuration host 13 and the ear module 10, the mobile phone 11, the linked companion microphone 12, and the other audio sources 22 are implemented using a control channel, such as a modified version of the Bluetooth® compliant serial port profile SPP protocol or a combination of the control channel and SCO channels. (See, for example, BLUETOOTH SPECIFICATION, SERIAL PORT PROFILE, Version 1.1, Part K:5, 22 Feb. 2001). Of course, a wide variety of other wireless communication technologies may be applied in alternative embodiments. The mobile phone 11 includes a display and a program that displays a measurement such as sound pressure level based on data delivered by the ear-level module, or in an alternative, based on data provided by a microphone or other sensor on the mobile phone itself. The mobile phone 11 also provides mobile phone functions including call setup, call answering and other basic telephone call management tasks in communication with a service provider on a wireless telephone network.

Companion modules, such as the companion microphone 12 consist of small components, such as a battery operated module designed to be worn on a lapel, that house “thin” data processing platforms, and therefore do not have the rich user interface needed to support configuration of private network communications to pair with the ear module. For example, thin platforms in this context do not include a keyboard or touch pad practically suitable for the entry of personal identification numbers or other authentication factors, network addresses, and so on. Thus, to establish a private connection pairing with the ear module, the radio is utilized in place of the user interface.

In embodiments described herein, each of the audio sources in communication with the ear module 10 may operate with a different subset of the set of variables stored on the ear module for audio processing, where each different subset is optimized for the particular audio source, and for the hearing profile of the user. The set of variables on the ear module 10 is stored in nonvolatile memory on the ear module, and includes for example, indicators for selecting data processing algorithms to be applied and parameters used by data processing algorithms.

The ear-level module is implemented with a microphone that is separate from the microphone on a companion mobile phone, and is preferably designed with a frequency response much broader than the typical telephone microphone. For example, the microphone and associated electronics on the ear module may handle frequencies up to 20 KHz or so, compared with the typical cellular phone designed to handle frequencies up to about 4 KHz. Also, the earpiece microphone and electronics are designed to handle higher sound levels, which are not processed in typical cell phones. The companion cell phone provides a display and supporting processing resources, presenting a graphical meter view that the user may easily read, based on the data retrieved from the ear-level module.

Using the microphone on the ear-level module, a measure of sound pressure is made, and processed to produce a sound pressure level measurement. A-weighting filters can be used. Other standard frequency weightings may be used, including B, C, and D weightings. Also, no weighting filters or non-standard weighting filters may be used.

An A-weighting process will produce results in units of dBA, which is a common measurement that approximates the response of the human ear to sound levels. The basic calculation performed using data processing resources on the ear-level module in embodiments that conserve radio bandwidth, includes computation of the Root Mean Square (RMS) value of sound pressure data from a microphone. This RMS value is divided by a standard reference level, averaged over a given time interval, expressed in decibels is the sound pressure level. The time interval may be 1 second, 10 seconds, 1 minute and so on, depending on the processing resources available, the time response of the measurement desired and so on.

In alternative systems, the environmental data sensed can be temperature, sensed using a temperature sensor on the ear-level module exposed to the environment, or body temperature sensed using a temperature sensor arranged to detect temperature within the ear canal, for example.

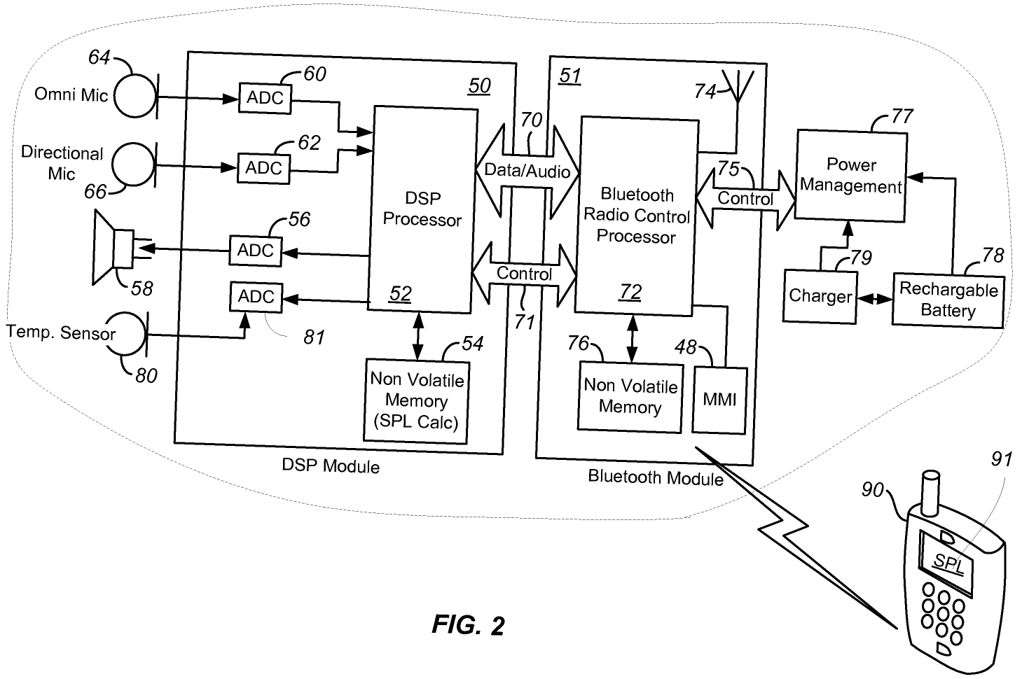

FIG. 2 is a system diagram for microelectronic and audio transducer components of a representative embodiment of the ear module 10. The system includes a data processing module 50 and a radio module 51. The data processing module includes a digital signal processor 52 (hence the reference to “DSP” in some of the Figures) coupled to nonvolatile memory 54. A digital-to-analog converter 56 converts digital output from the digital signal processor 52 into analog signals for supply to speaker 58 at the tip of the interior lobe of the ear module. A first analog-to-digital converter 60 and a second analog-to-digital converter 62 are coupled to the omnidirectional microphone 64 and a directional microphone 66, respectively, on the exterior lobe of the ear module. The analog-to-digital converters 60, 62 supply digital inputs to the digital signal processor 52. The embodiment shown also includes a temperature sensor 80, coupled via an analog-to-digital converter 81 to the DSP processor 52 for use in a mode delivering temperature measurements to the companion mobile phone 90.

The nonvolatile memory 54 stores computer programs that provide logic for processing the data from the microphone in digital form to provide a dBA measurement or other measurement data to the companion cell phone, and for controlling the ear module as described in more detail below. Alternatively, the sound pressure measurement may be done using analog circuitry, the output of which is converted to digital form for processing and transmission to the companion phone. In addition, the nonvolatile memory 54 stores a data structure for a set of variables used by the computer programs for audio processing, where each mode of operation of the ear module may have one or more separate subsets of the set of variables, referred to as “presets” herein.

The radio module 51 is coupled to the digital signal processor 52 by a data/audio bus 70 and a control bus 71. The radio module 51 includes, in this example, a Bluetooth® radio/baseband/control processor 72. The processor 72 is coupled to an antenna 74 and to nonvolatile memory 76. The nonvolatile memory 76 stores computer programs for operating a radio 72 and control parameters as known in the art. The processor module 51 also controls the man-machine interface 48 for the ear module 10, including accepting input data from the buttons and providing output data to the status light, according to well-known techniques.

The nonvolatile memory 76 is adapted to store at least first and second link parameters for establishing radio communication links with companion devices, in a respective data structure referred to as “pre-pairing slots” in nonvolatile memory. In the illustrated embodiment the first and second link parameters comprise authentication factors, such as Bluetooth® PIN codes, needed for pairing with companion devices. The first link parameter is preferably stored on the device as manufactured, and known to the user. Thus, it can be used for establishing radio communication with phones and the configuration host or other platforms that provide user input resources to input the PIN code. The second link parameter also comprises an authentication factor, such as a Bluetooth® PIN code, and is not pre-stored in the embodiment described herein. Rather the second link parameter is computed by the configuration host in the field, for private pairing of a companion module with the ear module. In one preferred embodiment, the second link parameter is unique to the pairing, and not known to the user. In this way, the ear module is able to recognize authenticated companion modules within a network which attempt communication with the ear module, without requiring the user to enter the known first link parameter at the companion module. Embodiments of the technology support a plurality of unique pairing link parameters in addition to the second link parameter, for connection to a plurality of variant sources of audio data using the radio.

In addition, the processing resources in the ear module include resources for establishing a configuration channel with a configuration host for retrieving the second link parameter, for establishing a first audio channel with the first link parameter, and for establishing a second audio channel with the second link parameter, in order to support a variety of audio sources.

Also, the configuration channel and audio channels comprise a plurality of connection protocols in the embodiment described herein. The channels include a control channel protocol, such as a modified SPP as mentioned above, and an audio streaming channel protocol, such as an SCO compliant channel. The data processing resources support role switching on the configuration and audio channels between the control and audio streaming protocols.

In an embodiment of the ear module, the data processing resources include logic supporting an extended API for the Bluetooth® SPP profile. The extended API can include a Sound Meter Mode (or similar mode for other environmental measurement data), in which the measurement data is transmitted to the companion mobile phone. Also, the extended API can include other extensions used as the control channel protocol for the configuration host and for the companion modules, including the following commands:
Echo—echoes the sent string back to the sender.
Pre-Pairing slot read—reads one of the pre-pairing slots.
Pre-Pairing Slot Set—sets one of the pre-pairing slots.
PSKEY set—generic state set. Used for changing Bluetooth® address amongst other things.
PSKEY Read—generic state read command. Has access to software version etc.
Battery Read—read battery voltage (in millivolts).
Report more on—turn on special report mode where certain things are reported to the computer without prompting.
MMI Control—control Man Machine Interface remotely.
LED control—set and clear LED's remotely.
PWR Off—for the LM, turn the LM off.
DSP send—send data to the DSP command port.
DSP read—read data from the DSP command port.
Volume Set—set the volume of the EP.
Volume Read—read the current volume of the EP.
Preset Set—set the “current program” of the EP.
Set Max Preset—set the maximum preset that the device will allow via the MMI.
Pairing off—exit pairing mode.
Mem Status—read the memory pool status.
Sound Meter Mode

In the illustrated embodiment, the data/audio bus 70 transfers pulse code modulated audio signals between the radio module 51 and the processor module 50. The control bus 71 in the illustrated embodiment comprises a serial bus for connecting universal asynchronous receive/transmit UART ports on the radio module 51 and on a processor module 50 for passing control signals.

A power control bus 75 couples the radio module 51 and the processor module 50 to power management circuitry 77. The power management circuitry 77 provides power to the microelectronic components on the ear module in both the processor module 50 and the radio module 51 using a rechargeable battery 78. A battery charger 79 is coupled to the battery 78 and the power management circuitry 77 for recharging the rechargeable battery 78.

The microelectronics and transducers shown in FIG. 2 are adapted to fit within the ear module 10.

The ear module operates in a plurality of modes, including in the illustrated example, a hearing aid mode for listening to conversation or ambient audio, a phone mode supporting a telephone call, and a companion microphone mode for playing audio picked up by the companion microphone which may be worn for example on the lapel of a friend. The signal flow in the device changes depending on which mode is currently in use. A hearing aid mode does not involve a wireless audio connection. The audio signals originate on the ear module itself. The phone mode and companion microphone mode involve audio data transfer using the radio. In the phone mode, audio data is both sent and received through a communication channel between the radio and the phone. In the companion microphone mode, the ear module receives a unidirectional audio data stream from the companion microphone.

The measurement data is provided to the companion mobile phone 90 in the phone mode, which provides a graphic meter display 91 readable by the user. Also, the ear-level module can be adapted to provide the measurement data on a periodic basis to the companion mobile phone in the hearing aid mode or in the companion microphone mode, or when a control signal is received indicating that the data is to be transmitted. The control signal can originate from the companion mobile phone 90, in response to user input selecting the meter display mode on the phone, or it can originate from the ear-level module in response to a threshold loudness in the environment or other environmental trigger.

The control circuitry is adapted to change modes in response to commands exchanged by the radio, and in response to user input, according to priority logic. For example, the system can change from the hearing aid mode to the phone mode and back to the hearing aid mode, the system can change from the hearing aid mode to the companion microphone mode and back to the hearing aid mode. For example, if the system is operating in hearing aid mode, a command from the radio which initiates the companion microphone may be received by the system, signaling a change to the companion microphone mode. In this case, the system loads audio processing variables (including preset parameters and configuration indicators) that are associated with the companion microphone mode. Then, the pulse code modulated data from the radio is received in the processor and up-sampled for use by the audio processing system and delivery of audio to the user. At this point, the system is operating in a companion microphone mode. To change out of the companion microphone mode, the system may receive a hearing aid mode command via the serial interface from the radio. In this case, the processor loads audio processing variables associated with the hearing aid mode. At this point, the system is again operating in the hearing aid mode.

If the system is operating in the hearing aid mode and receives a phone mode command from the control bus via the radio, it loads audio processing variables associated with the phone mode. Then, the processor starts processing the pulse code modulated data with an up-sampling algorithm for delivery to the audio processing algorithms selected for the phone mode and providing audio to the microphone. The processor also starts processing microphone data with a down-sampling algorithm for delivery to the radio and transmission to the phone. At this point, the system is operating in the phone mode. When the system receives a hearing aid mode command, it then loads the hearing aid audio processing variables and returns to hearing aid mode.

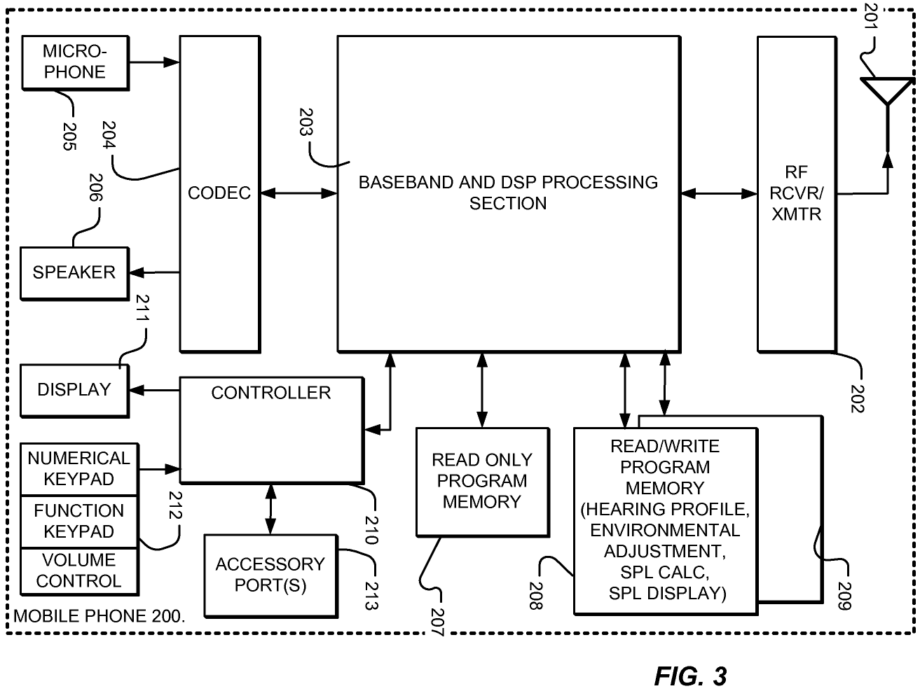

FIG. 3 is a simplified diagram of a mobile phone 200, representative of personal communication devices according to the present invention which provides resources for mobile phone functions including call setup, call answering and other basic telephone call management tasks in communication with a service provider on a wireless telephone network. The mobile phone 200 includes an antenna 201 and a radio including a radio frequency RF receiver/transmitter 202, by which the phone 200 is coupled to a wireless communication medium, according to one or more of a variety of protocols. In examples described herein, the RF receiver/transmitter 202 can include one or more radios to support multiprotocol/multiband communications for communication with the wireless service provider of the mobile phone network, as well as the establishment of wireless local radio links using a protocol like Bluetooth®. The receiver/transmitter 202 is coupled to baseband and digital signal processor DSP processing section 203, in which the audio signals are processed and call signals are managed. A codec 204, including analog-to-digital and digital-to-analog converters, is coupled to the processing section 203. A microphone 205 and a speaker 206 are coupled to the codec 204.

Read-only program memory 207 stores instructions, parameters and other data for execution by the processing section 203. In addition, a read/write memory 208 stores instructions, parameters and other data for use by the processing section 203. There may be multiple types of read/write memory on the phone 200, such as nonvolatile read/write memory 208 (flash memory or EEPROM for example) and volatile read/write memory 209 (DRAM or SRAM for example), as shown in FIG. 2. Other embodiments include removable memory modules in which instructions, parameters and other data for use by the processing section 203 are stored.

An input/output controller 210 is coupled to a display 211, to user input devices 212, such as a numerical keypad, a function keypad, and a volume control switch, and to an accessory port (or ports) 213. The accessory port or ports 213 are used for other types of input/output devices, such as binaural and monaural headphones, connections to processing devices such as PDAs, or personal computers, alternative communication channels such as an infrared port or Universal Serial Bus USB port, a portable storage device port, and other things. The controller 210 is coupled to the processing section 203. User input concerning call set up and management, and concerning use of the hearing profile, user preference and environmental noise factors is received via the input devices 212 and optionally via accessories. User interaction is enhanced, and the user is prompted to interact, using the display 211 and optionally other accessories. Input may also be received via the microphone 205 supported by voice recognition programs, and user interaction and prompting may utilize the speaker 206 for various purposes.

In the illustrated embodiment, memory 208 stores a program for computing a sound pressure level value, and for displaying the computed value on the display 211. The sound pressure level value is computed as described above, using the microphone 205 on the mobile phone 200. Alternatively, the memory 208 stores a program for communication with a companion ear-level module, as described above, in which the sound pressure level value is received from the ear-level module and displayed on the mobile phone 200.

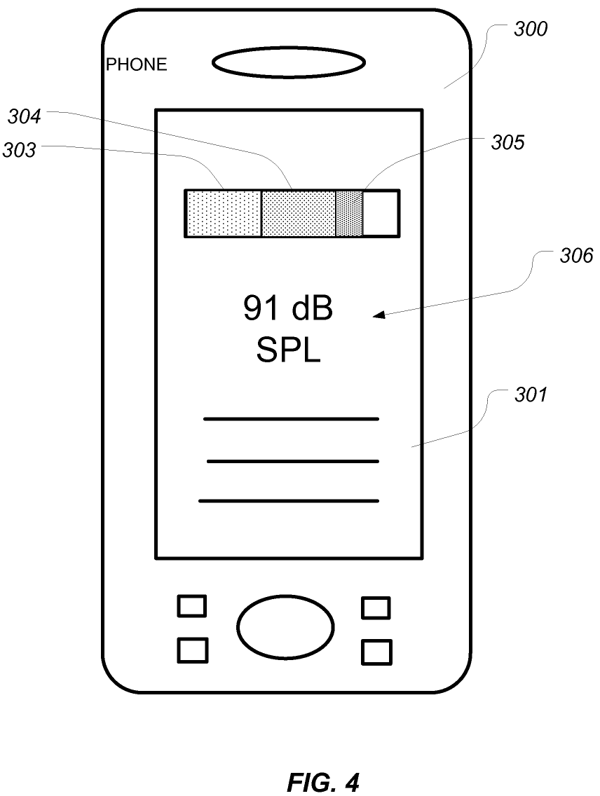

FIG. 4 shows a mobile phone 300 including a graphic display 301, showing A-weighted sound pressure level in dBA, as measured by sensor and processing resources either on a companion ear-level module or on the mobile phone 300. The display includes a color bar, which has a length corresponding to the measured sound pressure level, and which is color coded to indicate level. The three-color bar is a meter that shows the sound level. If the sound was quiet, only the first color (e.g. green) section 303 would show. As the sound gets louder, the bar increases in size and adds the different colors, such as a second color (e.g. orange) section 304 and a third color (e.g. red) section 305. So the bar length changes continuously with the sound level. Also, the display includes a numerical value 306 indicating the actual current measurement result, in an enlarged size for ease of reading. Similar graphic can be applied to display environmental temperature, body temperature, and other environmental measurements.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A device comprising:
an ear-level module including an audio transducer; one or more microphones, a user input, a radio and control circuitry which transmits and receives communication signals encoding audio data using the radio to and from a companion module;
wherein the control circuitry includes logic for producing a measurement of a characteristic of sound detected by the one or more microphones, and uses the radio to transmit data indicating the measurement to the companion module.

2. The device of claim 1, wherein said measurement is sound pressure level.

3. The device of claim 1, wherein said measurement is an A-weighted sound pressure level.

4. The device of claim 1, wherein said measurement is an indication of loudness near the ear-level module.

5. A device comprising:
an ear-level module including an audio transducer; one or more microphones, a user input, a radio and control circuitry which transmits and receives communication signals encoding audio data using the radio to and from a companion mobile phone;
wherein the control circuitry includes logic for producing a measurement of an environmental condition near the ear-level module, and uses the radio to transmit data indicating the measurement to the companion mobile phone or other hand held device.

6. The device of claim 5, wherein said measurement is temperature.

7. A mobile phone, comprising
a display;
resources providing mobile phone functions, including an audio transducer; a microphone, a user input, a radio and control circuitry; and
wherein the control circuitry includes processing resources for displaying a measurement on the display of a characteristic of sound, where the measurement is produced from one of sound detected by the microphone and data indicating the measurement received via a radio link from a companion module.

8. The phone of claim 7, wherein said measurement is sound pressure level.

9. The phone of claim 7, wherein said measurement is an A-weighted sound pressure level.

10. The phone of claim 7, wherein said measurement is an indication of loudness near the ear-level module.

11. The phone of claim 7, including a radio transmitter and receiver adapted for communication with an ear-level module, and the control circuitry includes resources for receiving the data indicating the measurement from the ear-level module.

12. A mobile phone, comprising
a display;
resources providing mobile phone functions, including an audio transducer; a microphone, a user input, a radio and control circuitry; and
wherein the control circuitry includes processing resources for displaying a measurement on the display of a characteristic of an environmental condition near the mobile phone, where the measurement is one of made based on data sensed at the mobile phone and data indicating the measurement received via a radio link from a companion module.

13. The phone of claim 12, wherein said measurement is temperature.

14. The phone of claim 12, including a radio transmitter and receiver adapted for communication with an ear-level module, and the control circuitry includes resources for receiving the data indicating the measurement from the ear-level module.

15. A method for operating a personal sound system including an ear-level module including a radio including a transmitter and a receiver adapted to transmit and receive communication signals which encode audio signals, an audio transducer, and control circuitry for establishing a communication link using the radio, and a companion module including a display, a radio including a transmitter and a receiver adapted to transmit communication signals on the communication link encoding audio signals, a microphone and control circuitry, the method comprising:
measuring an environmental condition using a sensor on the ear-level module;
establishing a radio communication link between the ear-level module and the companion module, and delivering data resulting from the measurement to the companion module using the radio communication link; and
displaying results of the measurements on the companion module.

16. The method of claim 15, wherein said measurement is sound pressure level.

17. The method of claim 15, wherein said measurement is an A-weighted sound pressure level.

18. The method of claim 15, wherein said measurement is an indication of loudness near the ear-level module.

19. The method of claim 15, wherein said measurement is temperature.

20. A method for operating a personal sound system including an ear-level module including a radio including a transmitter and a receiver adapted to transmit and receive communication signals which encode audio signals, an audio transducer, a microphone and control circuitry for establishing a communication link using the radio, and a companion mobile phone including a display, a radio including a transmitter and a receiver adapted to transmit communication signals on the communication link encoding audio signals, a microphone and control circuitry for performing mobile phone functions, the method comprising:
measuring sound pressure level of the microphone on the ear-level module;
establishing a radio communication link between the ear-level module and the companion mobile phone, and delivering data resulting from the measurement to the companion mobile phone using the radio communication link; and
displaying results of the measurement on the companion mobile phone.
